(19) United States
(12) Patent Application Publication
(10) Pub. No.: US 2019/0188646 A1
(43) Pub. Date: Jun. 20, 2019

(54) CANDIDATE SELECTION USING A GAMING FRAMEWORK

(71) Applicant: International Business Machines Corporation, Armonk, NY (US)

(72) Inventors: Sarthak Ahuja, New Delhi (IN); Ritwik Chaudhuri, New Delhi (IN); Manish Kataria, New Delhi (IN); Manu Kuchhal, Gurgaon (IN); Gyana Ranjan Parija, Gurgaon (IN); Sudhanshu Shekhar Singh, New Delhi (IN)

(21) Appl. No.: 15/842,066

(22) Filed: Dec. 14, 2017

(51) Int. Cl. G06Q 10/10; G06Q 10/06; H04L 29/08

(52) U.S. Cl. CPC G06Q 10/1053; H04L 67/306; G06Q 10/06311

(57) ABSTRACT

One embodiment provides a method, including: receiving a requisition for a job position, the requisition having a plurality of recruiters, each having influence in selecting a candidate; generating a profile for an ideal candidate comprising (i) a plurality of attributes and (ii) weights corresponding to each of the attributes; receiving, for a plurality of candidates, profiles for each the candidates; comparing the profile of each of the plurality of candidates against the ideal candidate, using a distance method computation to determine the distance between the plurality of candidates and the ideal candidate based upon the weights; ranking the plurality of candidates and providing the ranking to each of the plurality of recruiters; receiving input from each of the plurality of recruiters that modifies the ranking, recalculating the weights of the attributes based upon the modified ranking, and modifying the ranking; and providing a final ranking of the plurality of candidates.

### BACKGROUND

When a company needs to fill an open job position, the company generally creates a requisition for the open position. For example, a manager or other hiring personnel may generate a requisition for an open position. The requisition includes the requirements for the position, the desired attributes (e.g., education, skills, experience, etc.) of a candidate, and the like. In order to make the process more stream-lined a company may generate a generic requisition to be used for similar roles. Alternatively, the company may generate different generic portions to be used in generating the requisition for an open position. The hiring personnel may then use the generic portions that are germane to the open position to be filled by the hiring personnel.

When a candidate applies for the open position, the candidate submits a resume, application, or other document that details the candidate's attributes. The hiring personnel can compare the resume or application of the candidate to the requisition and requirements of the open position. The hiring personnel then make a decision on which candidates to bring in for an interview or to hire. However, this process is highly subjective and may not result in the best candidate being chosen for the open position.

### BRIEF SUMMARY

In summary, one aspect of the invention provides a method, comprising: utilizing at least one processor to execute computer code that performs the steps of: receiving, from a user, a requisition for a job position to be filled by a candidate, the requisition having a plurality of recruiters, each recruiter having influence in selecting a candidate to fill the job position; generating a profile for an ideal candidate using information corresponding to at least one employee having a role similar that of the job position, wherein the profile for the ideal candidate comprises (i) a plurality of attributes and (ii) weights corresponding to each of the attributes; receiving, for a plurality of candidates to be considered for the job position, respective profiles including attributes for each of the plurality of candidates; comparing the profile of each of the plurality of candidates against the generated profile of the ideal candidate, wherein the comparing comprises using a distance method computation to determine the distance between each of the plurality of candidates and the ideal candidate based upon the weights corresponding to each of the attributes; ranking the plurality of candidates based upon the comparison and providing the ranking to each of the plurality of recruiters; receiving input from each of the plurality of recruiters that modifies the ranking of the plurality of candidates, recalculating the weights of the attributes based upon the modified ranking by the recruiters, and modifying the ranking based upon the recalculated weights; and providing a final ranking of the plurality of candidates to the plurality of recruiters.

Another aspect of the invention provides an apparatus, comprising: at least one processor; and a computer readable storage medium having computer readable program code embodied therewith and executable by the at least one processor, the computer readable program code comprising: computer readable program code configured to receive, from a user, a requisition for a job position to be filled by a candidate, the requisition having a plurality of recruiters, each recruiter having influence in selecting a candidate to fill the job position; computer readable program code configured to generate a profile for an ideal candidate using information corresponding to at least one employee having a role similar that of the job position, wherein the profile for the ideal candidate comprises (i) a plurality of attributes and (ii) weights corresponding to each of the attributes; computer readable program code configured to receive, for a plurality of candidates to be considered for the job position, respective profiles including attributes for each of the plurality of candidates; computer readable program code configured to compare the profile of each of the plurality of candidates against the generated profile of the ideal candidate, wherein the comparing comprises using a distance method computation to determine the distance between each of the plurality of candidates and the ideal candidate based upon the weights corresponding to each of the attributes; computer readable program code configured to rank the plurality of candidates based upon the comparison and providing the ranking to each of the plurality of recruiters; computer readable program code configured to receive input from each of the plurality of recruiters that modifies the ranking of the plurality of candidates, recalculating the weights of the attributes based upon the modified ranking by the recruiters, and modifying the ranking based upon the recalculated weights; and computer readable program code configured to provide a final ranking of the plurality of candidates to the plurality of recruiters.

An additional aspect of the invention provides a computer program product, comprising: a computer readable storage medium having computer readable program code embodied therewith, the computer readable program code executable by a processor and comprising: computer readable program code configured to receive, from a user, a requisition for a job position to be filled by a candidate, the requisition having a plurality of recruiters, each recruiter having influence in selecting a candidate to fill the job position; computer readable program code configured to generate a profile for an ideal candidate using information corresponding to at least one employee having a role similar that of the job position, wherein the profile for the ideal candidate comprises (i) a plurality of attributes and (ii) weights corresponding to each of the attributes; computer readable program code configured to receive, for a plurality of candidates to be considered for the job position, respective profiles including attributes for each of the plurality of candidates; computer readable program code configured to compare the profile of each of the plurality of candidates against the generated profile of the ideal candidate, wherein the comparing comprises using a distance method computation to determine the distance between each of the plurality of candidates and the ideal candidate based upon the weights corresponding to each of the attributes; computer readable program code configured to rank the plurality of candidates based upon the comparison and providing the ranking to each of the plurality of recruiters; computer readable program code configured to receive input from each of the plurality of recruiters that modifies the ranking of the plurality of candidates, recalculating the weights of the attributes based upon the modified ranking by the recruiters, and modifying the ranking based upon the recalculated weights; and computer readable program code configured to provide a final ranking of the plurality of candidates to the plurality of recruiters.

A further aspect of the invention provides a method, comprising: utilizing at least one processor to execute computer code that performs the steps of: receiving a role fulfillment request, wherein the role fulfillment request has a plurality of associated decision makers for influencing a candidate selection; determining a profile of an ideal candidate by identifying (i) attributes and (ii) weights for each of the attributes using attributes captured from an employee who has been identified as a high performer; receiving, for candidates applying to fulfill the role, a plurality of profiles, each including a plurality of attributes; comparing each of the plurality of profiles of the candidates to the profile of the ideal candidate, identifying a difference between each of the plurality of profiles and the ideal candidate based upon the weights of the attributes, and ranking the plurality of candidates based upon the identified difference; providing the ranking to the plurality of associated decision makers and receiving input modifying the ranking of the plurality of candidates, wherein the modifying the ranking modifies the weights of the attributes; and generating a final ranking of the plurality of candidates based upon the modified attribute weights and providing the final ranking to the plurality of associated decision makers.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of ranking and selecting a candidate using a gaming framework.

FIG. 2 illustrates a round of candidate ranking based upon feedback from recruiters.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

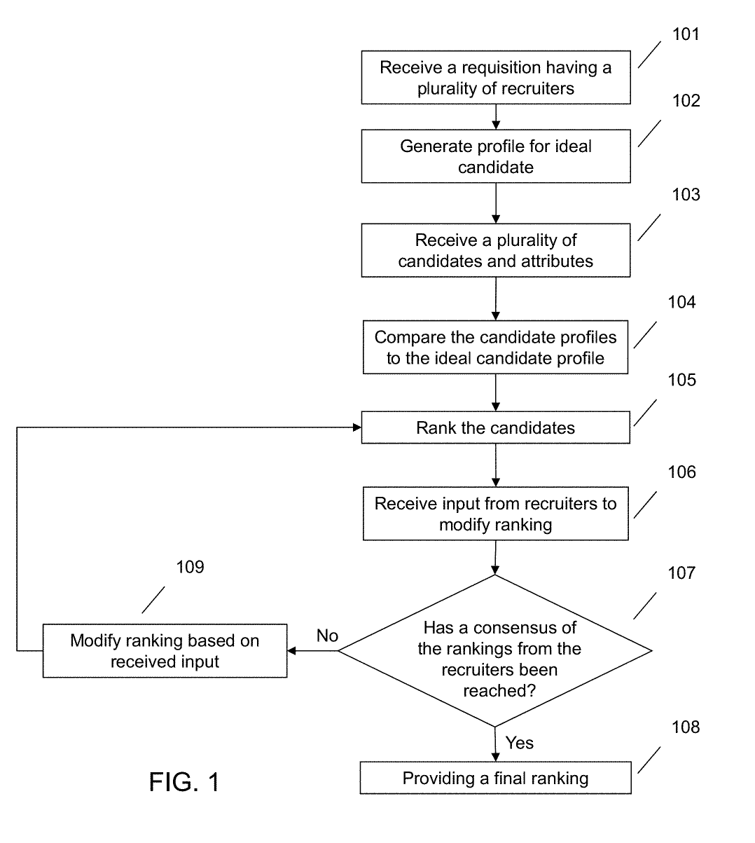

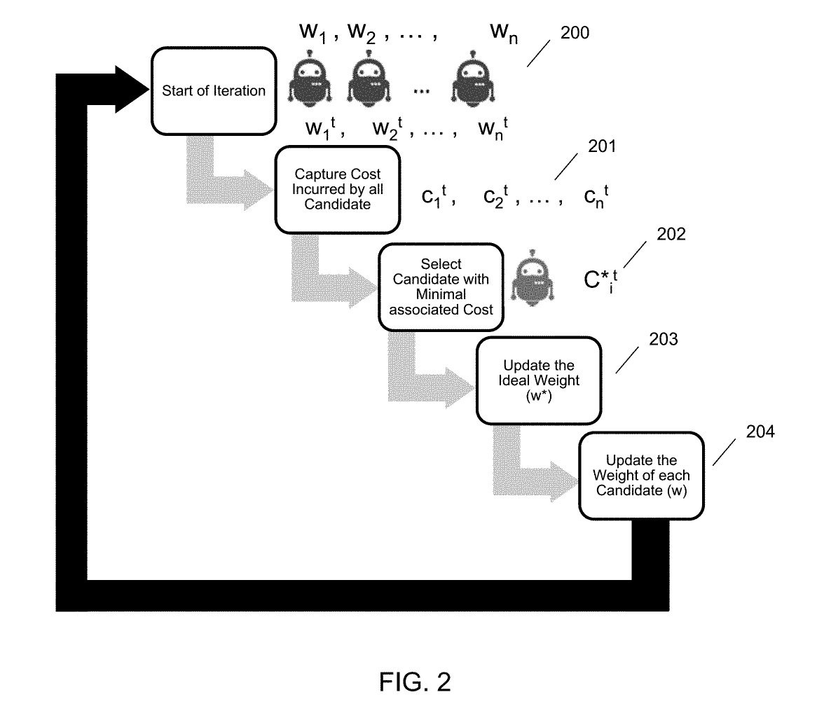

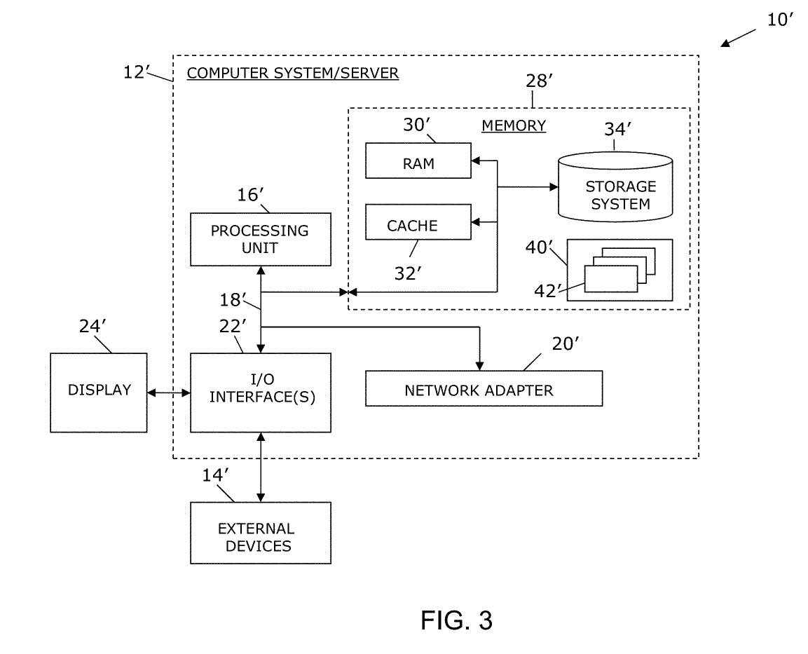

Specific reference will be made here below to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

When selecting a person to fill an open job position, it may be difficult to determine which candidate will thrive and be a high performer in the company and/or position. Additionally, different hiring personnel may have differing ideas regarding which attributes of a candidate result in an employee who performs well in the position. For example, one manager may have an open position and may feel that education is a good predictor of whether the person will perform as expected in the position, with experience being less important. However, a different manager having an open position for a similar role may feel that experience is a good predictor of whether the person will perform as expected in the position, with education being less important. However, these assessments or feelings may be based solely on experience with hiring and working with other people in similar positions and may be difficult to quantify. Additionally, the different hiring philosophies may result in dramatically different employees, not all being well suited for the position or role.

Some of the hiring process has been either automated or semi-automated. For example, different entities have attempted to at least partially automate the hiring solicitation process. For example, some companies require a specific requisition to be used when soliciting candidates for a particular position or role with the thought that all the candidates for that position will all have a similar background due to the generic requirements. As an example, a company may have a generic requisition that is used to hire an engineer for any group or department within the company. The problem with such an approach is that different groups or departments may have needs that are particular for that department or group. For example, one department may need an engineer who is knowledgeable about a particular system, whereas another group does not have the same requirement for an engineer. In response, the company may allow the hiring personnel to at least partially personalize the requisition, again resulting in a discrepancy among hired individuals.

Additionally, reviewing all applications or resumes received for a particular position can be very time-consuming, particularly if only a single person is reviewing the applications and/or resumes. Thus, the company may have a group or committee of hiring personnel that reviews the applications or resumes. The problem with this approach is that different people have different thoughts as to what attributes are important for a candidate. Thus, having different people review different applicants and qualifications of the applicants may result in a wide-range of differing applicants. In other words, the review process is not uniform or consistent across all the different reviewers, and good applicants may be missed and bad applicants may be chosen. Alternatively, the company may outsource the initial screening of the applicants to a third-party. The problem with this approach is that a third-party does not have direct knowledge of the position, hiring company culture, and the like. Thus, the only thing the third-party can do is directly compare the applicants against the requisition. Accordingly, some applicants may be dismissed because they are missing one attribute listed on the requisition even though the hiring company may not place much value on that attribute and would have otherwise at least interviewed the applicant.

Thus, attempts to at least partially automate the hiring screening process have been made. Traditionally these attempts have included using natural language or other language analysis techniques to parse and otherwise analyze applicant's documents against a requisition. However, such a technique suffers from the same problem as outsourcing the screening process to a third-party, namely that applicants are only compared against the requisition and no variations from that requisition are considered. Some systems are able to use historical information to learn about previously hired applicants having similar roles to a new requisition. This information may be used by the screening tool to attempt to identify deviations from the requisition that resulted in a selected candidate. These tools rely heavily on rules that are either programmed or learned by the tool. Thus, lower quality rules cause lower quality results. Additionally, the tools are generally unable to assess whether a candidate would be a good fit for the company, for example, whether the candidate will thrive in the culture of the company.

Some traditional systems may attempt to screen candidates based not only on the requisition, but on an identification of an ideal candidate. Attributes of the ideal candidate may be identified by hiring personnel. The system may compare an applicant candidate to the ideal candidate and determine how many of the attributes the candidate has when compared to the ideal candidate. The problem with this technique is that most, if not all, candidates are not going to have all the attributes of the ideal candidate. Thus, the attributes need to be weighted or prioritized to identify which attributes are most important and which are less important. As mentioned above, different hiring personnel may have different ideas about which attributes are most important. Thus, the screening process, again, becomes dependent on the hiring personnel, which is undesirable. Additionally, because different attributes have different levels of importance, it can be difficult to assign relative weights of importance to each of the attributes.

Accordingly, the techniques and systems as described herein provide a technique for screening and selecting job candidates using a gaming framework. The system receives a requisition for a job position (e.g., manager, associate, direct hire, engineer, scientist, etc.) to be filled by a candidate. The requisition has a plurality of associated recruiters or hiring personnel (e.g., human resources personnel, group manager, group lead, department supervisor, etc.). Each of the recruiters has influence on which candidate is selected and hired. In other words, each of the recruiters has a voice in identifying which candidate should be selected. The recruiters may have the same value of influence in the decision, or the recruiters may have different values of influence. For example, a manager of a group may have more influence in the hiring decision than a group lead may have.

The system may generate a profile for an ideal candidate using information associated with an employee who has a role similar to the identified role of the requisition and who has been identified as a high performer within the role. The ideal candidate profile may identify attributes of the ideal candidate and may also provide an initial weighting corresponding to each of these attributes. In other words, the ideal candidate profile may reflect a person who performs well in the position and which attributes of the employee have contributed to the success of the employee. Once the system receives a plurality of candidates to be considered for the job position, the system may compare the attributes of the candidates to the attributes of the ideal candidate and may rank the candidates based upon the reflected attributes and the weights corresponding to those attributes.

The system then provides this ranking to the plurality of recruiters and accepts input or feedback regarding the ranking of the candidates. This part of the system works in a series of rounds, where each round captures input regarding the ranking from each of the recruiters and then calculates new weights to assign to the attributes based upon the rankings provided by the recruiters. This causes the system to re-rank the candidates and this new ranking is again presented to all of the recruiters for feedback. This continues until either no changes to the rankings are identified by the recruiters or until the rankings cannot be modified any further to reach any better consensus among the recruiters. The final ranking is then provided to the recruiters, thereby identifying a highest ranking candidate for the recruiters' consideration.

Such a system provides a technical improvement over current techniques for screening and selecting job candidates. Rather than merely comparing the applicant to a requisition and finding the applicant who satisfies most, if not all, of the attributes of the requisition, the systems and methods as described herein allow for a technique to reach a consensus among a plurality of hiring personnel, also referred to herein as recruiters and agents. Thus, the system provides a semi-automated or fully automated system for screening and selecting candidates for an open position that results in less disparity among hired employees. Additionally, the system is able to assign relative weights to each of the attributes assisting in screening subsequent candidates for similar roles or positions. The system provides a more consistent hiring process across all departments of a company.

FIG. 1 illustrates a method for screening and selecting a candidate for filling an open job position using a gaming framework, for example, a public goods games framework. At 101 the system receives a requisition for a job position to be filled by a candidate. The requisition identifies a description of the job position and may also identify a plurality of attributes required or desired by the hiring personnel. For example, the requisition may identify specific skills or experience of an applicant that is necessary or requested for the position. The requisition may include a job posting, a completed questionnaire by hiring personnel identifying the desired attributes (e.g., experience, skills, education, competencies, cognitive traits, etc.), a past job posting for a similar position, or any other mechanism that allows the system to identify a role of the job position, desired attributes, and company associated with the job posting.

The requisition also has an associated plurality of recruiters, also referred to herein as hiring personnel or agents. The recruiters are those people within the hiring company that are responsible for making a decision regarding screening and selecting a candidate for employment within the position. The recruiters may include hiring managers, human resources personnel, department leads, potential co-workers, and the like. Each of the recruiters has influence in screening and selecting a candidate to fill the job position. Each of the recruiters may have the same value of influence in the selection of a candidate. Alternatively, the recruiters may each have a different value of influence in the decision for screening and selecting a candidate. For example, a co-worker may have less influence in the decision-making process than a manager. In other words, while the co-workers opinion may be important, it may not be as important as a manager's opinion. Depending on whether the influence of the recruiters is the same or different causes a different calculation regarding the ranking of the candidates, as discussed in more detail below.

Once the system identifies that a requisition has been or is being created, the system generates a profile for an ideal candidate at 102. In generating this profile, the system uses information corresponding to at least one employee having a role similar to the role of the job position. This employee may be an employee who is identified as a high performer or someone who works well within the role similar to the requisition role. For example, if the requisition is for a financial analyst, the system may identify other employees who are also financial analysts at the same or similar level as the requisitioned financial analyst. The employee may be a current employee, a past employee, combination of employees (e.g., certain attributes are identified from one employee and other attributes from a different employee, etc.), a made-up employee (e.g., attributes identified by hiring personnel as being ideal attributes, etc.), or the like.

The employee used for the basis of the ideal candidate may be identified by hiring personnel, for example, a hiring manager may identify one or more current employees that should be used for the basis of the ideal candidate, or may be identified by the system itself. The system may learn different attributes that result in an ideal candidate by accessing performance information associated with current or former employees having similar roles or positions to the requisition. For example, if the requisition is for a senior scientist having at least 10 years of experience, the system may access performance information for some or all senior scientists having at least 10 years of experience. The performance information may include performance reviews conducted by management and accessible by the system, work history or files accessible by the system, salary and/or promotion information, or any other information that may be indicative of the performance of an individual within a particular position. Using this information, the system may learn which individuals have succeeded or thrived within a particular position or the best performers within a position, identify attributes common between those individuals, and then identify these attributes as attributes of an ideal candidate.

In generating the ideal candidate profile the system may also assign or identify weights that correspond to the different attributes. The weights may designate an order or magnitude of importance of a particular attribute as compared to another attribute. In other words, each of the attributes of the ideal candidate may be considered more or less important than another attribute of the ideal candidate. The weights provide a mechanism for distinguishing the level of importance between different attributes and provide a mechanism for determining how important it is for a candidate to have that particular attribute.

The system may capture or obtain the weights based upon input provided by hiring personnel. For example, if a hiring manager has identified an ideal candidate, the hiring manager may identify or assign relative weights to each of the attributes. The system may then assign or identify the weights of the attributes based upon this designation by the hiring manager. The system may also create and assign default weights to each of the attributes. For example, if the ideal candidate has five identified attributes, the system may simply assign the same weight to each of the attributes, in this example, a weight of 20%. The weights may also be determined based upon historical information (e.g., using past requisitions that have been filled, etc.), learned from the attributes of the employees used as the basis for the ideal candidate, or the like.

As applicants apply for the open job position, the system may receive the information associated with each of these applicants or candidates at 103. The information may include profiles for each of the candidates which may include resumes of the applicants, applications of the candidates, questionnaires completed by the applicants, and the like. The profiles are used by the system to identify attributes for each of the plurality of candidates. Specifically, the system may capture attributes for each of the candidates that correspond to the attributes of the ideal candidate. As an example, if one of the ideal candidate attributes is education, the system may identify the education attribute for each of the plurality of candidates.

At 104 the system compares the profiles and attributes for each of the candidates against the attributes of the ideal candidate. For example, if the experience of the ideal candidate is identified as 10 years of experience in a management role, the system may compare the length of experience and the type of experience of the candidate against this attribute of the ideal candidate. Comparing the attributes of candidates to the ideal candidate may include using a distance method computation to create a distance score for each attribute of the candidate as compared with the ideal candidate. The distances are measured using a distance method that is defined over the space of all the candidates. The distances are additionally based upon the weights that correspond to each of the attributes. For example, if one attribute has a higher weight and the candidate does not have that attribute, the distance of that candidate as compared to the ideal candidate may be greater than the distance of a candidate not having an attribute having a lower weight and having the attribute having the higher weight.

Using the computed distances, the system may initially rank the plurality of candidates at 105. The ranking may be based upon calculating a cost function associated with each of the candidates. The cost function calculation may be based upon the computed distances for each of the attributes and the weights associated with those attributes. In calculating the cost function, the system may identify each of the attributes and the weight associated with the attribute and multiply this weight by the distance for each identified attribute of the candidate. The system may then sum these results to determine an overall cost for each candidate, for example, referring to FIG. 2 at 201. The system may then rank each of the candidates based upon the overall cost for the candidates, specifically the system may identify the candidate having the least associated cost, at 202, and rank this candidate at the highest ranking. The candidate having the second least associated cost may then be ranked at the second highest ranking, and so on. In other words, the system may rank the candidates in ascending order based upon the calculated cost associated with each of the candidates.

The system may then provide this ranking to each of the plurality of recruiters, for example, the recruiters identified at 101. The system also provides, to the recruiters, the weights of each of the attributes that the system used in identifying the initial ranking of the plurality of candidates. The distance method is defined using a public goods game space where each recruiter is represented by an agent. Each of the agents may have a particular weightage that the agent generally assigns to each of the attributes. Thus, the agent may have associated default weights for each of the attributes that are assigned to the agent when the rankings and initial weights are provided to each agent. The system may also provide the default weights of each of the other agents to each agent and provide a comparison of the weights used by the system in the ranking as compared to that agent's default weights. The system may also provide a comparison of the weights used by the system in the ranking or the agent's default weights as compared to the default weights of other agents within the game space.

Based on this information the agent may provide input to the system that modifies the ranking of the candidates at 106. The input may include a direct modification of the ranking, for example, the agent identifying a different ranking for the candidates. Alternatively, or in combination, the input may include an indirect modification of the ranking, for example, the agent modifying the weights used by the system (e.g., the weights of the ideal candidate attributes, etc.) or modifying the default weights associated with the agent. The system allows each agent to provide feedback for the rankings in a single round. Once a round is completed, the system determines at 107 if a consensus of rankings from the agents has been reached. A consensus includes a ranking where all the agents agree with the ranking, all agents have converted to the same weights, or if no further weight conversions are possible. If a consensus has not been reached, the system modifies the rankings based upon the received input at 109.

Modifying the ranking includes recalculating the weights of the attributes based upon the input provided by the agents. Recalculating the weights of the attributes includes identifying attributes having a higher or lower importance as compared to the initial ranking based upon the input provided by the agents. The system may calculate a convergence associated with each attribute based upon the initial weights and the weights provided by the agents. The system then modifies the weight of each attribute until the convergence is below a particular value. In recalculating the weights of the attributes the system considers whether each agent has the same influence weight or not. If each of the agents has the same influence weight, as briefly mentioned above, the system considers each ranking provided by each agent the same as a ranking provided by a different agent. If, however, the agents have different influence weights, the system weights the rankings provided by each agent according to the influence weight of that agent. In other words, if one agent has a higher influence weight than another agent, the ranking of that agent more heavily influences the recalculation of attribute weights performed by the system.

Based upon the recalculated weights of the attributes, the system updates the weight for each attribute of the ideal candidate, for example, at 203. Using these new attribute weights, the system updates the weight of each candidate at 204 and begins a new round at 200. The system then calculates the cost function associated with each candidate 201, identifies the candidate having the least cost 202, and re-ranks the candidates, at 105. This re-ranking is then again provided to the agents for input. The system then receives additional input from each of the agents in the round at 106, and then, after the round is complete, determines if a consensus of rankings has been reached. If a consensus has not been reached, the system again modifies the ranking at 109 and starts another round.

Once a consensus has been reached at 107, the system provides the final ranking of the candidates to the plurality of recruiters at 108. This final ranking identifies the candidate from the plurality of candidates that is most like the ideal candidate identified at 102. The recruiters may then use this information in making further hiring decisions in the job candidate selection process.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
utilizing at least one processor to execute computer code that performs the steps of:
receiving, from a user, a requisition for a job position to be filled by a candidate, the requisition having a plurality of recruiters, each recruiter having influence in selecting a candidate to fill the job position;
generating a profile for an ideal candidate using information corresponding to at least one employee having a role similar that of the job position, wherein the profile for the ideal candidate comprises (i) a plurality of attributes and (ii) weights corresponding to each of the attributes;
receiving, for a plurality of candidates to be considered for the job position, respective profiles including attributes for each of the plurality of candidates;
comparing the profile of each of the plurality of candidates against the generated profile of the ideal candidate, wherein the comparing comprises using a distance method computation to determine the distance between each of the plurality of candidates and the ideal candidate based upon the weights corresponding to each of the attributes;
ranking the plurality of candidates based upon the comparison and providing the ranking to each of the plurality of recruiters;
receiving input from each of the plurality of recruiters that modifies the ranking of the plurality of candidates, recalculating the weights of the attributes based upon the modified ranking by the recruiters, and modifying the ranking based upon the recalculated weights; and
providing a final ranking of the plurality of candidates to the plurality of recruiters.

2. The method of claim 1, wherein the at least one employee is identified as an ideal candidate by the user.

3. The method of claim 1, wherein the at least one employee is determined using performance information of existing employees and identifying an employee from the existing employees having the best performance.

4. The method of claim 1, wherein the distance method computation is defined over the space of all of the plurality of candidates.

5. The method of claim 1, wherein the recalculating the weights of the attributes comprises minimizing the cost function between the weights of the attributes and weights associated with the modified rankings of the recruiters.

6. The method of claim 1, wherein each recruiter has the same influence as each other recruiter and wherein the input provided by each recruiter is weighted the same.

7. The method of claim 1, wherein at least one recruiter has a greater influence than at least one other recruiter.

8. The method of claim 7, wherein the input provided by the at least one recruiter having greater influence has a higher weighting than a recruiter having lower influence.

9. The method of claim 1, wherein the ranking comprises calculating a cost function associated with each of the plurality of candidates and ranking the candidates in ascending order based upon the cost associated with each of the plurality of candidates.

10. The method of claim 1, wherein the final ranking is provided when the plurality of recruiters reach a consensus.

11. An apparatus, comprising:
at least one processor; and
a computer readable storage medium having computer readable program code embodied therewith and executable by the at least one processor, the computer readable program code comprising:
computer readable program code configured to receive, from a user, a requisition for a job position to be filled by a candidate, the requisition having a plurality of recruiters, each recruiter having influence in selecting a candidate to fill the job position;
computer readable program code configured to generate a profile for an ideal candidate using information corresponding to at least one employee having a role similar that of the job position, wherein the profile for the ideal candidate comprises (i) a plurality of attributes and (ii) weights corresponding to each of the attributes;
computer readable program code configured to receive, for a plurality of candidates to be considered for the job position, respective profiles including attributes for each of the plurality of candidates;
computer readable program code configured to compare the profile of each of the plurality of candidates against the generated profile of the ideal candidate, wherein the comparing comprises using a distance method computation to determine the distance between each of the plurality of candidates and the ideal candidate based upon the weights corresponding to each of the attributes;
computer readable program code configured to rank the plurality of candidates based upon the comparison and providing the ranking to each of the plurality of recruiters;
computer readable program code configured to receive input from each of the plurality of recruiters that modifies the ranking of the plurality of candidates, recalculating the weights of the attributes based upon the modified ranking by the recruiters, and modifying the ranking based upon the recalculated weights; and
computer readable program code configured to provide a final ranking of the plurality of candidates to the plurality of recruiters.

12. A computer program product, comprising:
a computer readable storage medium having computer readable program code embodied therewith, the computer readable program code executable by a processor and comprising:
computer readable program code configured to receive, from a user, a requisition for a job position to be filled by a candidate, the requisition having a plurality of recruiters, each recruiter having influence in selecting a candidate to fill the job position;
computer readable program code configured to generate a profile for an ideal candidate using information corresponding to at least one employee having a role similar that of the job position, wherein the profile for the ideal candidate comprises (i) a plurality of attributes and (ii) weights corresponding to each of the attributes;
computer readable program code configured to receive, for a plurality of candidates to be considered for the job position, respective profiles including attributes for each of the plurality of candidates;
computer readable program code configured to compare the profile of each of the plurality of candidates against the generated profile of the ideal candidate, wherein the comparing comprises using a distance method computation to determine the distance between each of the plurality of candidates and the ideal candidate based upon the weights corresponding to each of the attributes;
computer readable program code configured to rank the plurality of candidates based upon the comparison and providing the ranking to each of the plurality of recruiters;
computer readable program code configured to receive input from each of the plurality of recruiters that modifies the ranking of the plurality of candidates, recalculating the weights of the attributes based upon the modified ranking by the recruiters, and modifying the ranking based upon the recalculated weights; and
computer readable program code configured to provide a final ranking of the plurality of candidates to the plurality of recruiters.

13. The computer program product of claim 12, wherein the at least one employee is identified as an ideal candidate by the user.

14. The computer program product of claim 12, wherein the at least one employee is determined using performance information of existing employees and identifying an employee from the existing employees having the best performance.

15. The computer program product of claim 12, wherein the distance method computation is defined over the space of all of the plurality of candidates.

16. The computer program product of claim 12, wherein the recalculating the weights of the attributes comprises minimizing the cost function between the weights of the attributes and weights associated with the modified rankings of the recruiters.

17. The computer program product of claim 12, wherein each recruiter has the same influence as each other recruiter and wherein the input provided by each recruiter is weighted the same.

18. The computer program product of claim 12, wherein at least one recruiter has greater influence than at least one other recruiter and wherein the input provided by the at least one recruiter having greater influence has a higher weighting than a recruiter having lower influence.

19. The computer program product of claim 12, wherein the final ranking is provided when the plurality of recruiters reach a consensus.

20. A method, comprising:
utilizing at least one processor to execute computer code that performs the steps of:
receiving a role fulfillment request, wherein the role fulfillment request has a plurality of associated decision makers for influencing a candidate selection;
determining a profile of an ideal candidate by identifying (i) attributes and (ii) weights for each of the attributes using attributes captured from an employee who has been identified as a high performer;
receiving, for candidates applying to fulfill the role, a plurality of profiles, each including a plurality of attributes;
comparing each of the plurality of profiles of the candidates to the profile of the ideal candidate, identifying a difference between each of the plurality of profiles and the ideal candidate based upon the weights of the attributes, and ranking the plurality of candidates based upon the identified difference;
providing the ranking to the plurality of associated decision makers and receiving input modifying the ranking of the plurality of candidates, wherein the modifying the ranking modifies the weights of the attributes; and
generating a final ranking of the plurality of candidates based upon the modified attribute weights and providing the final ranking to the plurality of associated decision makers.
